(19) United States
(12) Patent Application Publication
(10) Pub. No.: US 2006/0077773 A1
(43) Pub. Date: Apr. 13, 2006

(54) Method and apparatus for reproducing data from recording medium using local storage

(76) Inventors: Kang Soo Seo, Anyang-si (KR); Jea Yong Yoo, Seoul (KR); Byung Jin Kim, Seongnam-si (KR)

Correspondence Address: HARNESS, DICKEY & PIERCE, P.L.C., P.O. BOX 8910, RESTON, VA, 20195, US

(21) Appl. No.: 11/224,245

(22) Filed: Sep. 13, 2005

Related U.S. Application Data
(60) Provisional application No. 60/608,884, filed on Sep. 13, 2004.
(60) Provisional application No. 60/632,645, filed on Dec. 3, 2004.

(30) Foreign Application Priority Data
Dec. 23, 2004 (KR) 10-2004-0111095

(51) Int. Cl. G11B 21/08

(52) U.S. Cl. 369/30.09

(57) ABSTRACT

A method and apparatus for reproducing data from a recording medium using a local storage is disclosed. The apparatus for reproducing data of a recording medium, wherein original data constructing a first title and a second title having different attributes is recorded, using a local storage includes a local storage for downloading additional data associated with the first title and/or the second title from an external part, and storing the downloaded additional data; and a playback system for forming a virtual file system to reproduce the original data and the additional data, and reproducing the first title or the second title. The playback system includes a first module for reproducing the original data and the additional data, which are associated with the first title; and a second module for reproducing the original data and the additional data, which are associated with the second title.

This application claims the benefit of Korean Patent Application No. 10-2004-0111095, filed on Dec. 23, 2004, which is hereby incorporated by reference as if fully set forth herein.

This application claims the benefit of the U.S. Provisional Application No. 60/608,884, filed on Sep. 13, 2004, in the name of inventors Kang Soo SEO, Jae Yong YOO, and Byung Jin KIM, entitled “METHOD OF USING LOCAL STORAGE IN BLU-RAY DISC”, and No. 60/632,645, filed on Dec. 3, 2004, in the name of inventors Kang Soo SEO, Jae Yong YOO, and Byung Jin KIM, entitled “METHOD OF MANAGING LOCAL STORAGE FOR HIGH DENSITY OPTICAL DISC”, which are hereby incorporated by reference as if fully set forth herein.

### BACKGROUND OF THE INVENTION

1. Field of the Invention

The present invention relates to a method and apparatus for reproducing data from a recording medium, and more particularly to a method and apparatus for reproducing data from a recording medium using a local storage contained in an optical recording/reproducing device.

2. Discussion of the Related Art

Generally, there has been widely used an optical disc acting as a recording medium capable of recording a large amount, of data therein. Particularly, there has recently been developed a high-density optical recording medium capable of recording/storing high-quality video data and high-quality audio data for a long period of time, for example, a Blu-ray Disc (BD).

The BD based on the next-generation recording medium technique has been considered to be the next-generation optical recording solution capable of storing much more data than a conventional DVb. In recent times, many developers have conducted intensive research into the international standard technical specification associated with the BD along with those of other digital devices.

In association with the above-mentioned situation, there has recently been developed an optical recording/reproducing device based on the BD international standard, but the BD international standard has not yet been completed, such that many limitations and problems occur in developing the optical recording/reproducing device.

Particularly, the above-mentioned optical recording/reproducing device must consider not only a basic function for recording/reproducing data of the BD, but also an additional function for enabling the optical recording/reproducing device to interact with peripheral digital devices. In other words, the optical recording/reproducing device must receive an external input signal, must display the received signal, and must reproduce desired data using the external input signal and the BD.

However, an apparatus for reproducing data from the recording medium to simultaneously reproduce the external input signal and data of the BD has not yet been established, such that many limitations and problems occur in developing a BD-based optical recording/reproducing device.

### SUMMARY OF THE INVENTION

Accordingly, the present invention is directed to a method and apparatus for reproducing data from a recording medium using a local storage that substantially obviate one or more problems due to limitations and disadvantages of the related art.

An object of the present invention is to provide a method and apparatus for reproducing data suitable for a recording medium.

Another object of the present invention is to provide a method for providing a playback system which includes a local storage capable of receiving/storing data from an external part, and simultaneously reproduces data stored in the local storage and data recorded in a recording medium.

A further object of the present invention is to provide a method and apparatus for reproducing both data recorded in a, recording medium and data stored in a local storage using a playback system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for reproducing data of a recording medium wherein original data constructing a first title and a second title having different attributes is recorded, using a local storage, includes a local storage for downloading additional data associated with the first title and/or the second title from an external part, and storing the downloaded additional data; a playback system for forming a virtual file system to reproduce the original data and the additional data, and reproducing the first title or the second title, wherein the playback system includes a first module for reproducing the original data and the additional data, which are associated with the first title; and a second module for reproducing the original data and the additional data, which are associated with the second title.

In another aspect of the present invention, an apparatus for reproducing data of a recording medium using a local storage includes a recording/reproducing unit for reading original data from the recording medium; a local storage for downloading additional data associated with the recording medium from an external part, and storing the downloaded additional data; a selection unit for selecting the original data or the additional data, and selecting a decoding path of the selected original data or a decoding path of the selected additional data; and a decoder for including at least two decoding paths, and performing a decoding operation according to the selected data and the selected decoding path of the selection unit.

In another aspect of the present invention, a method for reproducing data of a recording medium using a local storage includes the steps of (a) reading a binding unit associated with a loaded recording medium from the local storage; (b) performing a binding operation for combining the binding unit with a file structure contained in the recording medium, and forming a virtual package in which a playlist file including a main path and a sub-path is contained; and (c) separating a first path capable of decoding a stream of the main path from the playlist file, separating a second path capable of decoding a stream of the sub-path from the playlist file, and decoding the first path and the second path in different ways.

In a further aspect of the present invention, a method for reproducing data of a recording medium using a local storage includes the steps of (a) reading original data from a recording medium; (b) downloading additional data associated with the recording medium from an external part, and storing the downloaded additional data; (c) selecting the original data or the additional data, and selecting a decoding path of the selected original data or a decoding path of the selected additional data; and (d) performing a decoding operation according to the selected data and the selected decoding path.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram illustrating a method and apparatus for reproducing data from a recording medium according to the present invention;

FIG. 2 is a conceptual diagram illustrating a file structure recorded in an optical disc acting as a recording medium and a method for reproducing a specific title using the file structure;

FIG. 3 is a structural diagram illustrating a data record structure of an optical disc acting as a recording medium according to the present invention;

FIGS. 4a□4b are conceptual diagrams illustrating a reproduction relationship of a specific title according to the file structure shown in FIG. 2, FIG. 4a is a conceptual diagram illustrating a reproduction relationship of a specific title using the index file “index.bdj”, and FIG. 4b is a conceptual diagram illustrating a reproduction relationship of a clip using the playlist file;

FIG. 5 is a block diagram illustrating an optical recording/reproducing device according to the present invention;

FIG. 6 is a block diagram illustrating an apparatus for reproducing data from a recording medium using a playback system according to the present invention;

FIG. 7 is a method for forming a virtual package according to the present invention;

FIG. 8 is a conceptual diagram illustrating a relationship between the playback system and file information contained in the virtual package according to the present invention;

FIG. 9 exemplarily shows a variety of additional data types stored in a local storage according to the present invention;

FIG. 10a is a block diagram illustrating a decoder for use in the playback system according to a first preferred embodiment of the present invention; and

FIG. 10b is a block diagram illustrating a decoder for use in the playback system according to a second preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method and apparatus for reproducing data from a recording medium using a local storage will hereinafter be described with reference to the annexed drawings.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

A recording medium for use in the present invention is indicative of all storage mediums, for example, an optical disc, and a magnetic tape, etc., according to various recording schemes. For the convenience of description and better understanding of the present invention, the optical disc, such as a BD, will hereinafter be exemplarily used as the above-mentioned recording medium in the present invention. It should be noted that technical ideas of the present invention can be applied to other recording mediums without departing from the scope and spirit of the invention.

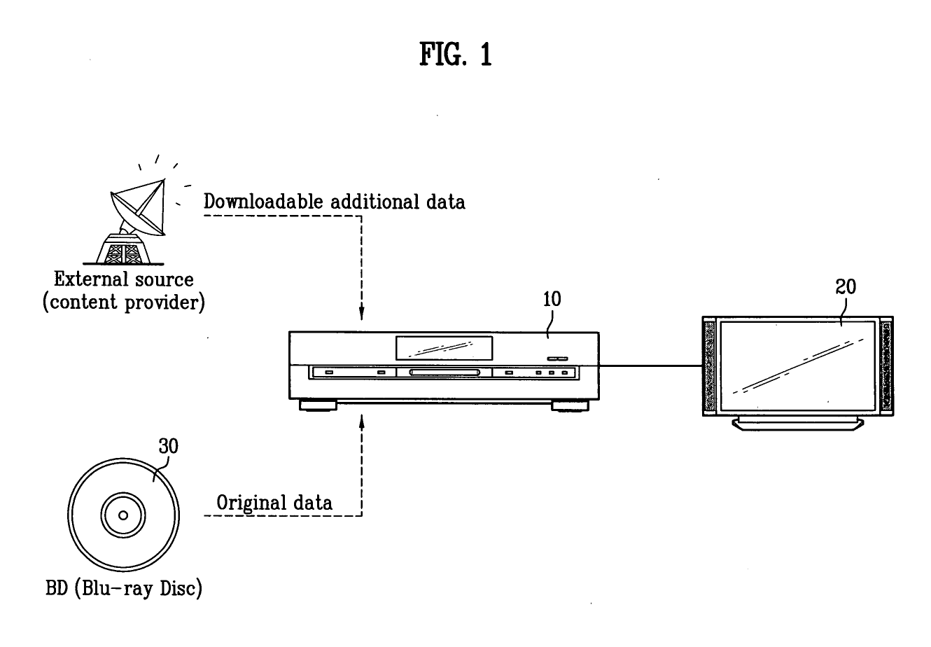

The term “local storage” is indicative of a storage unit contained in an optical recording/reproducing device 10 shown in FIG. 1. In more detail, the term “local storage” is indicative of a component capable of receiving necessary information or data from a user, and storing the received information or data. For example, a general local storage may be indicative of a Hard Disc Drive (HDD), but it should be noted that the term “local storage” of the present invention is not limited to the HDD, and is applicable to other examples as necessary.

Particularly, the term “local storage” is indicative of a storage unit for storing data associated with a recording medium such as a BD. The data associated with the recording medium is generally downloaded from an external device. In association with the above-mentioned description, it is obvious to those skilled in the art that the local storage may directly read some permission data from the recording medium, and may generate system data (e.g., metadata) associated with record/reproduction operations of the recording medium, such that the system data may be stored in the local storage.

The term “binding unit” is indicative of a set of files stored in the local storage. Particularly, the binding unit is indicative of a set of information (i.e., information set) associated with a specific recording medium. In this case, the information set is combined with or is added to a file contained in the recording medium, such that it can simultaneously reproduce data of the recording medium and data of the local storage. A detailed description of the binding unit will be given later.

For the convenience of description, data recorded in the recording medium is referred to as “original data”, data associated with the recording medium from among a plurality of data units stored in the local storage is referred to as “additional data”.

FIG. 1 is a conceptual diagram illustrating a method and apparatus for reproducing data according to the present invention. Unified usages of the optical recording/reproducing 10 and peripheral devices are shown in FIG. 1.

The optical recording/reproducing device 10 can record/reproduce data in/from various optical discs having different formats. If necessary, the optical recording/reproducing device 10 can record/reproduce specific data in/from only a specific optical disc such as a BD, or can reproduce the data from the optical disc without recording the data in the same. It should be noted that the present invention exemplarily uses a BD-player capable of reproducing data from the BD or a BD-recorder capable of recording data in the BD in consideration of correlation between the BD and peripheral devices for the convenience of description.

The optical recording/reproducing device 10 records or reproduces data in/from the optical disc 30, receives an external input signal, performs a signal process on the received signal, and transmits the signal processed result to the external display 20, such that a user can view the signal processed result on the display 20. In this case, there is no limitation in a receivable external signal. For example, representative external input signals may be determined to be a DTV-associated signal and an Internet-associated signal, etc. Specifically, the Internet is indicative of a communication network to which a user easily gains access, such that the user can download specific Internet data using the optical recording/reproducing device 10, and can use the downloaded data. In association with the above-mentioned description, a person for providing content data used as an external source is generally referred to as a content provider (CP).

When original data is recorded in the optical disc 30 seated in the optical recording/reproducing device 10, and additional data associated with the original data is present in other storage places (e.g., Internet), the present invention aims to reproduce the original data and the additional data at the same time.

For example, it is assumed that multiplexed AV (Audio/Video) streams are recorded as the original data recorded in the optical disc, and additional data for use in the Internet is an audio stream different from an audio stream (e.g., Korean) of the original data. In this case, some users may download a specific audio stream (e.g., English) acting as additional data from the Internet, may desire to reproduce the downloaded audio stream along with the AV stream acting as original data, or may desire to reproduce only the additional data. In order to implement the above-mentioned desires of the users, correlation between the original data and the additional data must be established, and there is needed a systemized method for managing/reproducing the above-mentioned data according to a user request.

For the convenience of description, although a signal recorded in the disc is called the original data, and other signals existing in the outside of the disc are called the additional data, it should be noted that the original data and the additional data are not limited to only specific data.

Generally, additional data may be indicative of audio data, presentation graphic (PG) data, interactive graphic data, or text subtitle, etc., but the additional data may also be indicative of a multiplexed AV stream including the above-mentioned data and video data. In other words, data associated with the original data simultaneously existing in the outside of the optical disc may act as additional data. Additional data types and reproduction methods of individual additional data types will be described later.

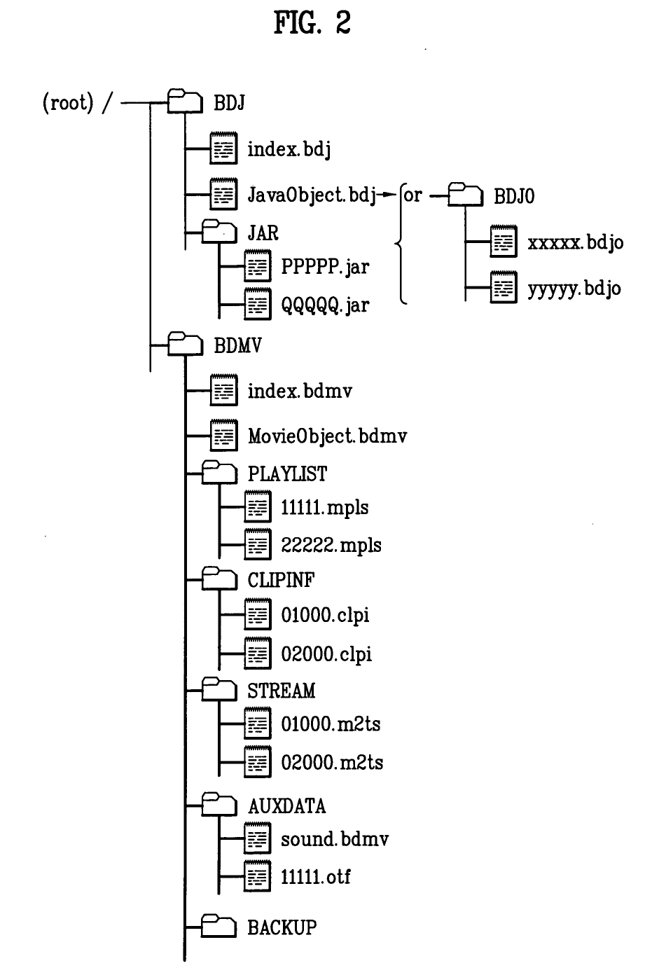

In order to satisfy the above-mentioned user requests, a predetermined file structure must be established between the original data and the additional data. Accordingly, a file structure and data record structure for use in the BD will hereinafter be described with reference to FIGS. 2□3.

FIG. 2 is a conceptual diagram illustrating a file structure for reproducing/managing the original data recorded in an optical disc, and a method for reproducing a specific title according to the file structure.

In association with the above-mentioned description, the disc according to the present invention is indicative of a recording medium which includes data having different attributes. For example, the disc includes movie title data composed of general moving images, Java title data of a Java program, and/or enhanced data added to the movie title data.

Therefore, the file structure according to the present invention includes two BD directories under a single root directory, i.e., a BD Java directory (BDJ) and a BD movie directory (BDMV).

In association with the above-mentioned description, the BD movie directory (BDMV) includes not only an index file “index.bdmv” acting as a general file (i.e., an upper file) capable of guaranteeing user interactivity, but also the movie object file “MovieObject.bdmv”. The file structure includes a variety of directories for storing the movie title data actually recorded in a disc, for example, a playlist directory (PLAYLIST), a clip information directory (CLIPINF), a stream directory (STREAM), an auxiliary directory (AUXDATA), and a backup directory (BACKUP). The above-mentioned directories and a variety of files included in the directory will hereinafter be described.

The AUXDATA directory includes an additional data file for reproducing data of the disc. For example, the AUXDATA directory includes a “Sound.bdmv” file for providing a user with sound data when an interactive graphic function is executed, and an “11111.otf” file for providing the user with font information when data of the disc is reproduced.

The stream directory (STREAM) includes a plurality of AV stream files recorded in a disc according to a specific format. Generally, individual streams are recorded using an MPEG-2 based transport packet, and the stream directory (STREAM) uses extension names of stream files (01000.m2ts and 02000.m2ts) as a specific extension name “*.m2ts”. Particularly, if video/audio/graphic information from among the above-mentioned streams is multiplexed, the multiplexed information is called an AV stream, and a movie title is composed of at least one AV stream file.

The clip information (Clip-info) directory (CLIPINF) is composed of a plurality of clip-info files (01000.clpi and 02000.clpi) connected to the above-mentioned stream files on a one-to-one basis. Particularly, the clip-info files (*.clpi) record attribute information and timing information of the stream files (*.m2ts) therein. The clip-info files (*.clpi) connected to the stream files (*.m2ts) on a one-to-one basis are generically named a “Clip”. In other words, this means that a single clip is indicative of data composed of a stream file (*.m2ts) and a clip-info file (*.clpi). A clip recorded in the disc is referred to as an original clip. A clip, which is downloaded and stored in a local storage, is referred to as an additional clip.

The playlist directory (PLAYLIST) includes a plurality of playlist files (*.mpls). Each playlist file (*.mpls) includes one or more playitems (PlayItem) and one or more sub-playitems (SubPlayItem). Each playitem (PlayItem) and each sub-playitem (SubPlayItem) are adapted to manage reproduction of a specific clip. The playitem (PlayItem) and the sub-playitem (SubPlayItem) include information associated with a specific clip to be reproduced, i.e., information associated with a reproduction start time (IN-Time) and other information associated with a reproduction termination time (OUT-Time) of the specific clip.

In association with the above-mentioned description, a process for reproducing data using at least one playitem (PlayItem) in the playlist file is referred to as a main path, and a process for reproducing data using individual sub-play items (SubPlayItem) is referred to as a sub-path. The playlist file must contain a single main path. The playlist file may contain at least one sub-path according to the presence or absence of the sub-playitem (SubPlayItem) as necessary.

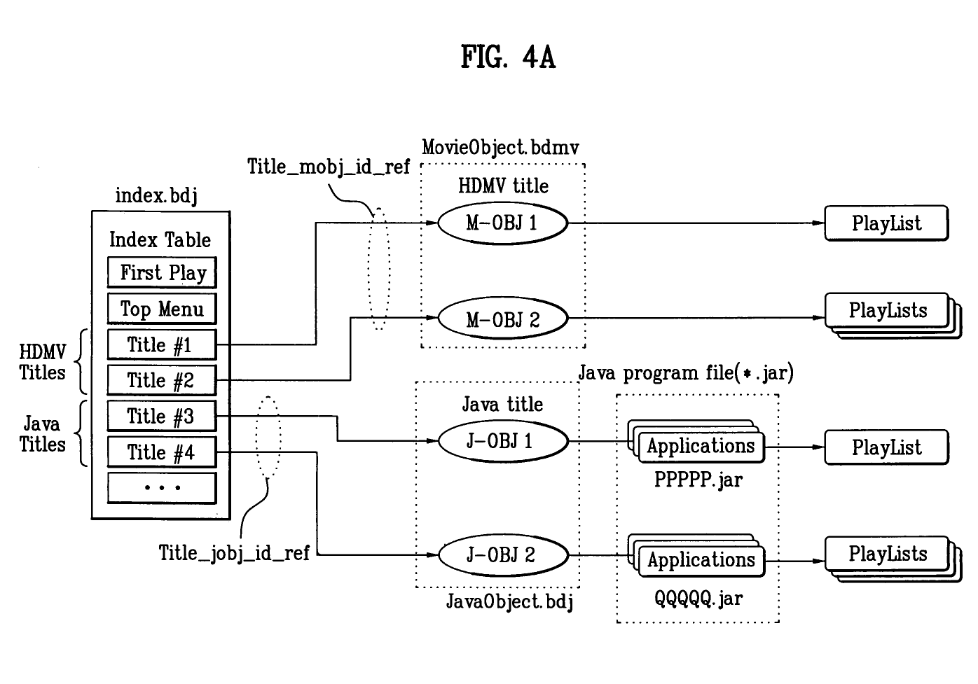

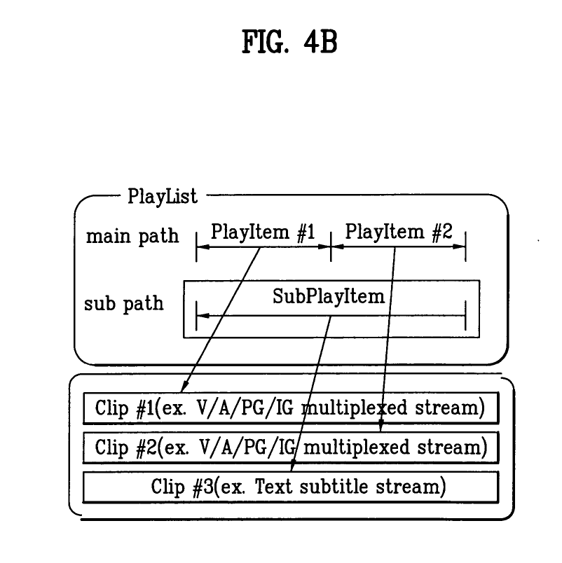

In conclusion, the playlist file acts as a basic reproduction/management file unit contained in overall reproduction/management file structures for reproducing a desired clip by combination of one or more playitems (PlayItem). In association with the above-mentioned description, reproduction of the clip using the playlist file will be described later with reference to FIG. 4b.

The backup directory (BACKUP) stores a plurality of duplicate files, i.e., a duplicate file (also called “copied files”) of the index file “index.bdmv” storing information associated with disc reproduction, a duplicate file of the movie object file “MovieObject.bdmv”, duplicate files of all playlist files (*.mpls) contained in the playlist directory (PLAYLIST), and duplicate files of all clip-info files (*.clpi) contained in the clip-info directory (CLIPINF). If the above-mentioned files (“index.bdmv”, “MovieObject.bdmv”, “*.mpls”, and “*.clpi”) are damaged, a disc reproduction process is also fatally damaged, such that the backup directory (BACKUP) is designed to pre-store duplicate files of the above-mentioned files as backup files.

The file structure includes a BD Java directory (BDJ) for managing disc reproduction associated with Java program under a root directory. The BD Java directory (BDJ) includes an index file “index.bdj” acting as a general file (i.e., an upper file) capable of guaranteeing user interactivity, the Java object file “JavaObject.bdj”, and a Java directory (JAR) composed of Java program files (“PPPPP.jar” and “QQQQQ.jar”).

In association with the above-mentioned description, the index file “index.bdj” contained in the BD Java directory (BDJ) provides index information associated with all titles (i.e., movie titles and Java titles) of the disc, but the other index file “index.bdmv” contained in the BD movie directory (BDMV) provides index information associated with only the movie titles. Therefore, if the optical recording/reproducing device can reproduce only the movie titles, it may refer to the index file “index.bdmv” contained in the BD movie directory (BDMV). However, if the optical recording/reproducing device 10 can reproduce all titles (i.e., movie titles and Java titles), it may refer to an index file “in dex.bdj” contained in the BD Java directory (BDJ).

In FIG. 2, the Java object file “JavaObject.bdj” contained in the BD Java directory (BDJ) manages a plurality of Java objects as a single file. For anther example, an additional Java object directory (BDJO) is contained in the BD Java directory (BDJ), Java object files “xxxxx.bdjo” and “yyyyy.bdjo” of individual Java objects are contained in the corresponding Java Object directory (BDJO).

Operations and structures of the index file “index.bdj”, the Java object file “JavaObject.bdj”, and the Java program file (*.jar) in the BD Java directory (BDJ) will be described later with reference to FIG. 4a.

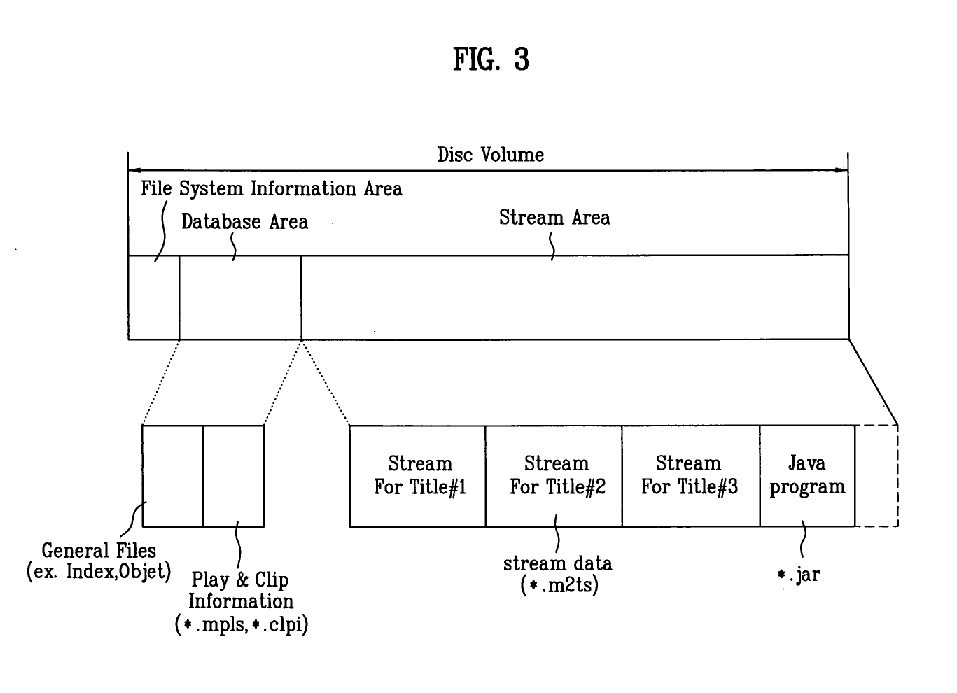

FIG. 3 is a structural diagram illustrating a data record structure recorded in a recording medium according to the present invention. In more detail, FIG. 3 shows a disc record format of information associated with the file structure. As shown in FIG. 3, from the viewpoint of an inner area of the disc, the above-mentioned disc structure sequentially includes a file system information area serving as system information for managing overall files, a database area for recording a playlist file and a clip-info file to reproduce a recorded AV stream (*.m2ts), an AV stream area for recording a plurality of streams composed of audio data, video data, and graphic data, etc., and a stream area for recording, a Java program file (*.jar). Particularly, it should be noted that data recorded in the stream area of the disc may be determined to be original data, as previously stated above.

FIGS. 4a□4b are conceptual diagrams illustrating a reproduction relationship of a specific title according to the file structure shown in FIG. 2. FIG. 4a is a conceptual diagram illustrating a reproduction scenario of a specific title using the index file “index.bdj”. FIG. 4b is a conceptual diagram illustrating a reproduction scenario of a clip using the playlist file. In association with the above-mentioned description, a reproduction scenario associated with the object file is referred to as a dynamic scenario, and a reproduction scenario associated with the playlist file is referred to as a static scenario.

Referring to FIG. 4a, different titles are recorded in the disc, and individual titles are provided to a user as menu information contained in the index file. For example, titles #1 and #2 contained in the disc may be composed of movie titles (also called HDMV titles, and titles #3 and #4 contained in the disc may be composed of Java titles).

The index file (index.bdj) includes first playback information “First Playback” indicative of information associated with a first reproduction image when data of a corresponding disc is loaded, and top menu information “Top_Menu” for providing a menu image.

If the disc having the above-mentioned file structure is loaded in the optical recording/reproducing device 10, the HDMV titles #1 and #2 and the Java titles #3 and #4 are reproduced by either a specific title reproduction selection command of a user or a reproduction scenario recorded in the disc.

In association with the above-mentioned description, if the title #1 or #2 acting as the HDMV title is reproduced, the object “M-OBJ 1” linked to the title #1 and the other object “M-OBJ 2” linked to the title #2 are executed. A specific playlist file for reproducing the title #1 or #2 is executed by a command contained in the movie object “M-OBJ 1” or “M-OBJ 2”. Therefore, individual syntaxes of the titles #1 and #2 in the index file “index.bdj” contain “Title_mobj_id_ref” information for executing a movie object linked to a corresponding title.

In association with the above-mentioned description, if the title #3 or #4 acting as the Java title is reproduced, the object “J-OBJ 1” linked to the title #3 and the other object “J-OBJ 2” linked to the title #4 are executed. A specific command for loading a specific Java program is recorded in the Java objects “J-OBJ 1” and “J-OBJ 2”, such that Java program files (e.g., “PPPPP.jar” or “QQQQQ.jar”) designated by the Java object (J-OBJ) are executed. The Java program files may be comprised of a plurality of applications. Each application may include a command program for reproducing a specific playlist file.

Therefore, individual syntaxes of the Java titles #3 and #4 in the index file “index.bdj” contain “Title_jobj_id_ref” information for executing a Java object linked to a corresponding title.

In association with the above-mentioned description, if an additional Java object (BDJO) is contained in the BD Java directory (BDJ), and Java object files “xxxxx.bdjo” and “yyyyy.bdjo” of individual Java objects are contained in the corresponding Java Object directory (BDJO), syntaxes of the Java titles #3 and #4 in the index file “index.bdj” may record “job_file_name” information instead of “Title_jobj_id_ref” information.

FIG. 4b is a conceptual diagram illustrating a method for reproducing a specific title according to the file structure shown in FIG. 2. In more detail, FIG. 4b is a conceptual diagram illustrating a method for reproducing a clip of a specific tile using a playlist file.

As previously stated in FIG. 4a, in order to reproduce a specific title, a specific playlist file is executed via the index file “index.bdj” and the object “M-OBJ” or “J-OBJ”. Each playlist file includes at least one playitem (PlayItem) and at least one sub-playitem (SubPlayItem) to manage reproduction of a specific clip.

For example, the playlist file includes two playitems (PlayItems #1 and #2) contained in a main path as shown in FIG. 4b. The playitem #1 (PlayItem #1) reproduces/manages the clip #1 in which video data, audio data, and graphic data of a specific title are multiplexed. The playitem #2 (PlayItem #2) reproduces/manages the clip #2 in which video data, audio data, and graphic data of a specific title are multiplexed. Also, the playlist file further includes a single sub-playitem (SubPlayitem) in a sub-path. The clip #3 indicative of a text subtitle stream associated with the specific title is reproduced/managed by the sub-playitem (SubPlayItem).

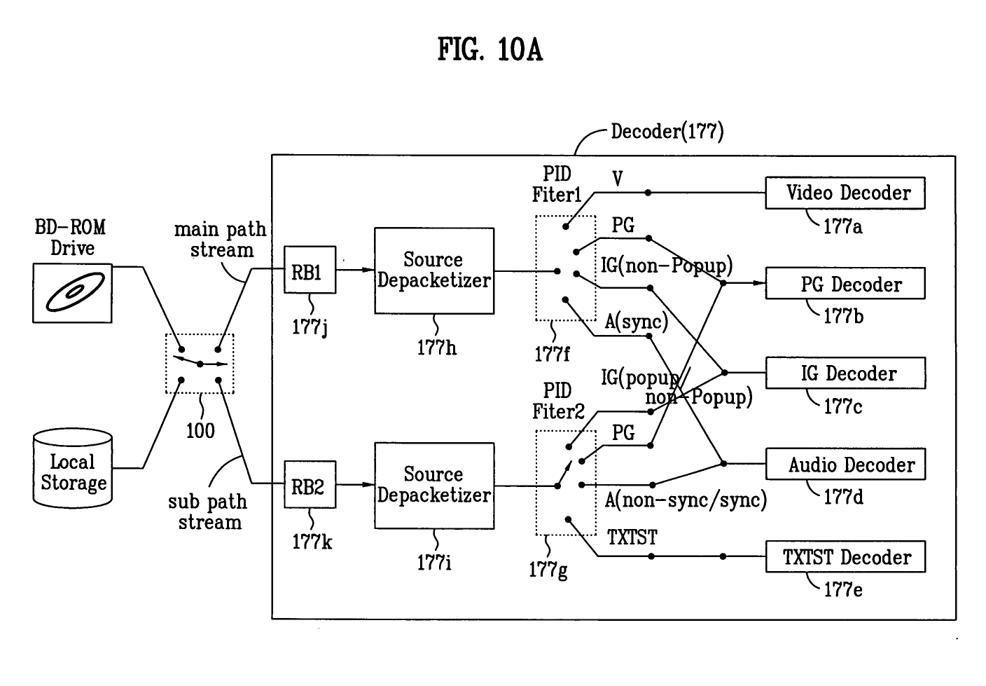

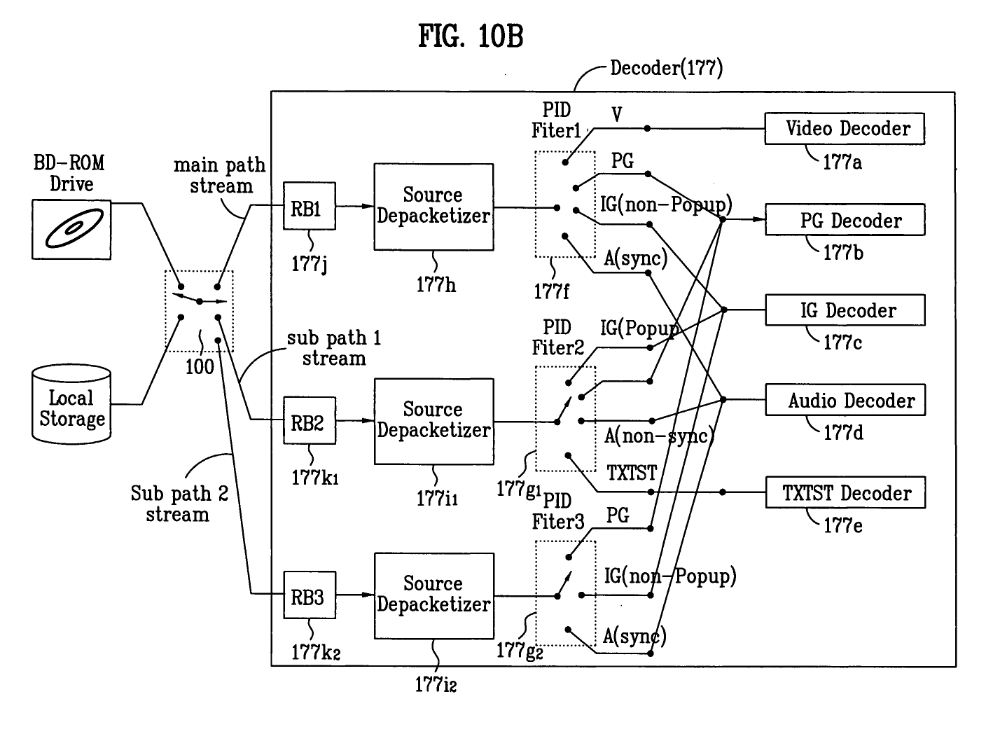

In association with the above-mentioned description, a decoder 177 according to the present invention uses different paths to decode a plurality of clips reproduced/managed while being classified according to the main path and the sub-path contained in the playlist file. A detailed description thereof will hereinafter be described with reference to FIGS. 10a□10b.

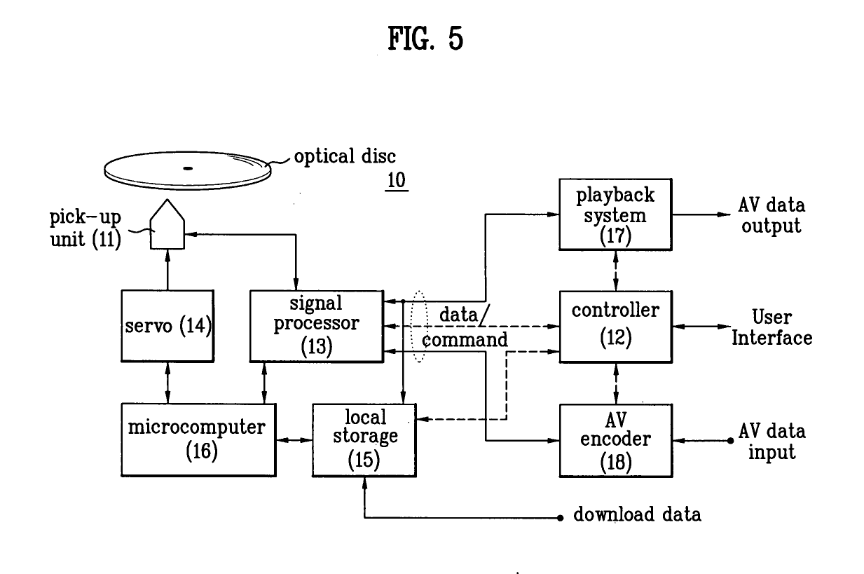

FIG. 5 is a block diagram illustrating the optical recording/reproducing device 10 according to the present invention.

Referring to FIG. 5, the optical recording/reproducing device 10 includes a pickup unit 11, a servo unit 14, a signal processor 13, and a microprocessor 16. The pickup unit 11 reproduces original data recorded in the optical disc and management information including reproduction/management file information. The servo unit 14 controls operations of the pickup unit 11. The signal processor 13 receives a reproduction signal from the pickup unit 11, restores the received reproduction signal to a desired signal value, or modulates a signal to be recorded into another signal recorded in the optical disc, such that it transmits the restored or modulated result. The microprocessor 16 controls mutual operations of the above-mentioned components. A device including the above-mentioned components, i.e., the pickup unit 11, the servo unit 14, the signal processor 13, and the microprocessor 16, is referred to as a recording/reproducing unit or a drive.

A playback system 17 is indicative of a playback unit for simultaneously reproducing data recorded in a disc and data recorded in a local storage. The playback system 17 downloads additional data present in an external source, stores the downloaded additional data in the local storage 15, and configures a virtual file system (VFS) to reproduce the original data recorded in the optical disc and the additional data stored in the local storage. The playback system 17 forms a virtual package including the original data and associated additional data using the virtual file system (VFS), and reproduces the original data and/or the additional data using the formed virtual package upon receiving a request from a user. In association with the above-mentioned description, a detailed description of the virtual file system (VFS) and the virtual package will hereinafter be described with reference to FIGS. 608.

An encoder 18 converts an input signal into a specific format signal (e.g., an MPEG2 transport stream) upon receiving a control signal from the controller 12, and transmits the converted result to the signal processor 13.

The controller 12 controls all the constituent components of the optical recording/reproducing device 10. Specifically, the controller 12 receives a user command by interfacing with a user, and uses the received command to control the above-mentioned constituent components.

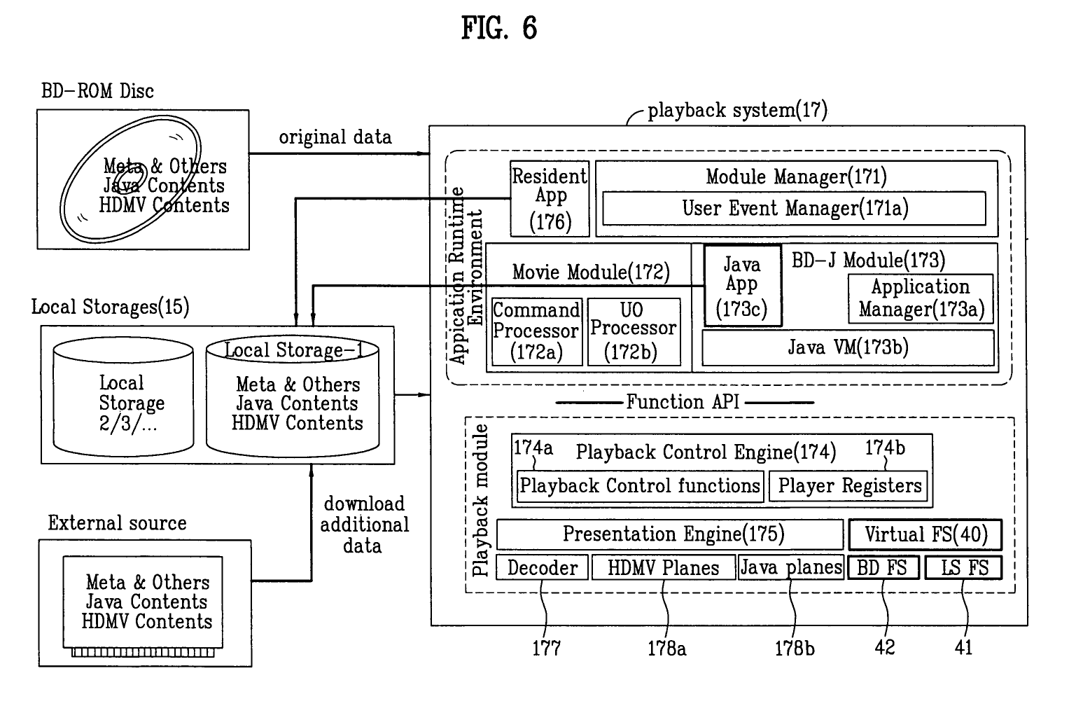

FIG. 6 is a block diagram illustrating an apparatus for reproducing data from a recording medium using the playback system 17 according to the present invention.

In association with the above-mentioned description, the term “playback system” is indicative of a collective reproduction processor implemented by software and/or hardware contained in the optical recording/reproducing device. The playback system is indicative of a system which reproduces data, of a recording medium loaded in the optical recording/reproducing device, and at the same time reproduces/manages data (e.g., data downloaded from an external part) stored in the local storage in association with the recording medium.

Specifically, the playback system includes a module manager 171, a movie module 172, a BDJ module 173, a playback control engine 174, and a presentation engine 175. A detailed description thereof will hereinafter be described.

The movie module 172 acting as an additional reproduction process module capable of reproducing the HDMV title and the BDJ module 173 acting as an additional reproduction process module capable of reproducing the Java title are constructed independently of each other. The movie module 172 receives a command or program contained in the above-mentioned object “M-OBJ”, and the BDJ module 173 receives a command or program contained in the above-mentioned object “J-OBJ”, such that the movie module 172 and the BDJ module 173 process the received command or program. The movie module 172 includes a command processor 172a, and the BDJ module 173 includes an application manager 173a and a JAVA VM 173b, such that the movie module 172 and the BDJ module 173 are capable of receiving/processing the above-mentioned command.

The player model shown in FIG. 10b includes the module manager 171, the playback control engine 174, and the presentation engine 175. The module manager 171 transmits a user command to the movie module 172 and the BDJ module 173, and controls operations of the BDJ module 173. The playback control engine 174 analyzes playlist file content recorded in a disc upon receiving a reproduction command from the movie module 172 and the BDJ module 173, and performs a reproduction function on the basis of the analyzed result. The presentation engine 175 displays a specific stream reproduced/managed by the playback control engine 174.

The playback control engine 174 includes a playback control function 174a for managing all the reproduction operations; a player status register (PSR) for indicating a reproduction environment or reproduction status of the player; and a player register 174b for storing general purpose register (GPR) information. The playback control function 174b may also be indicative of the playback control engine 174 as necessary.

The module manager 171, the movie module 172, the BDJ module 173, and the playback control engine 174 contained in the playback system can be processed by software. It is preferable that the above-mentioned components 171, 172, 173, and the 174 are processed by software instead of hardware. The presentation engine 175, the decoder 177, the HDMV graphic planes 178a, and the Java graphic planes 178b are generally hardware based. Constituent components (e.g., 171, 172, 173, and 174) processed by software may be integrated in one unit, such that the integrated unit may be installed into the controller 12. Therefore, it should be noted that the above-mentioned components of the present invention be understood on the basis of their meanings, and are not limited to their implementation methods such as hardware or software implementation.

In association with the above-mentioned description, the characteristics of the playback system 17 are as follows.

Firstly, as stated above, the movie module 172 for the HDMV title and the BDJ module 173 for the Java title are configured independently of each other, and the two modules 172 and 173 cannot be executed at the same time. In more detail, the Java title cannot be reproduced when the HDMV title is reproduced, and the HDMV title cannot be reproduced when the Java title is reproduced.

Secondly, the playback system includes the Java application 173c in the BDJ module 173. The Java application 173c acts as a program for managing a network function of an optical recording/reproducing device, such that the playback system can download additional data from the external source.

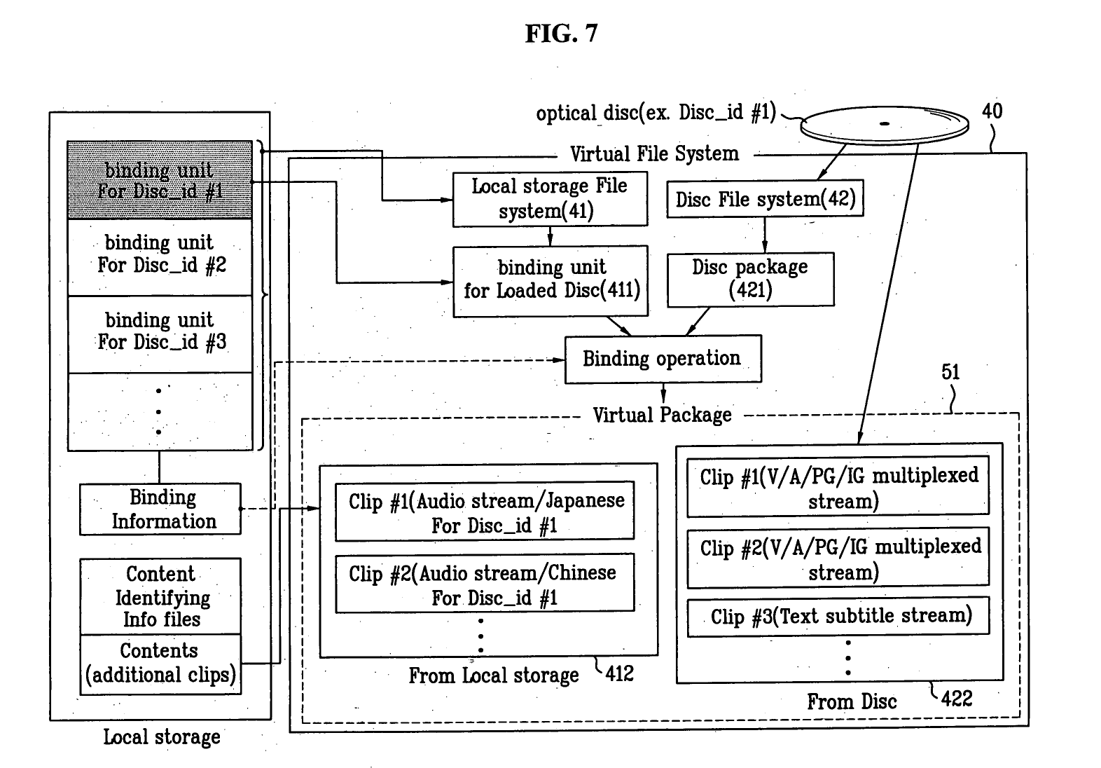

Thirdly, the playback system includes a resident application 176 for actually managing the local storage 15, such that it can form a virtual package by editing files stored in the local storage 15 or combining the files with the disc file structure. In other words, the resident application 176 forms a virtual file system (Virtual FS) 40 capable of managing a BD file system 42 and a local storage file system (LS FS) 41 as a single system, and forms/manages the virtual package for reproducing original data and additional data using the virtual file system (Virtual FS) 40. In association with the above-mentioned description, a method for forming the virtual package using the virtual file system (Virtual FS) will be described with reference to FIGS. 7□8.

Fourthly, the HDMV title and the Java title receive user commands based on different schemes, respectively. The HDMV title and the Java title use different methods for performing individual user commands. There is needed a predetermined unit capable of receiving the user command, and transmitting the received user command to either the movie module 172 or the BDJ module 173. In this case, the above-mentioned operations are performed by the user event manager 171a contained in the module manager 171. For example, if the received command is determined to be a user command entered by a User Operation (UO), the user event manager 171a transmits the user command to a UO controller 172b contained in the movie module 172. Otherwise, if the received command is determined to be a user command entered by a key event, the user event manager 171a transmits the received user command to the Java VM 173b contained in the BDJ module 173.

Fifthly, one of the modules 172 and 173 manages the above-mentioned playback control engine 174. In more detail, when reproducing the HDMV title, the movie module 172 acts as a master of the playback control engine 174. When reproducing the Java title, the BDJ module 173 acts as a master of the playback control engine 174.

Sixthly, the graphic plane is independently managed. For example, the HDMV planes 178a control the presentation engine 175 to act as a master. The Java planes 178b control the Java VM 173b contained in the BDJ module 173 to act as a master.

FIG. 7 is a method for forming a virtual package according to the present invention. A method for forming the virtual package is executed by the resident application 176.

In association with the above-mentioned description, information stored in the local storage 15 will hereinafter be described. The local storage 15 includes a plurality of binding units (binding unit for Disc_id #n) combined with individual discs according to disc IDs. Directory and file names of each binding unit are equal to those of the disc file structure shown in FIG. 2. Also, the local storage 15 may further include binding information combined with the disc file, structure, and a file (i.e., Contents Identifying Info files) for explaining stored content data.

Specifically, the number of the binding units (binding unit for Disc_id #n) contained in the local storage 15 is determined to be a plural number to cope with different discs, such that an additional file system for managing the binding units is additionally used. This additional file system is equal to the above-mentioned local storage file system 41. The local storage file system 41 manages all the files (i.e., additional clips for the purpose of the present invention and other files unrelated to the present invention) stored in the local storage 15.

Therefore, if an optical disc (e.g., Disc_id =#1) having a specific disc ID (Disc_id) is loaded in the optical recording/reproducing device 10, the controller 12 contained in the optical recording/reproducing device 10 recognizes ID information of the loaded disc using the pickup unit 11 and the signal processor 13, reads a binding unit 411 (denoted by “binding unit for loaded disc”) whose ID information is identical with the ID information of the loaded disc from among a plurality of binding units stored in the local storage 15, combines the read information with a disc package 421 acting as a disc file structure, forms a virtual package 41, and reproduces original data recorded in the disc and additional data recorded in the local storage using the virtual package 51.

In more detail, if a specific disc is loaded on the condition that a binding unit combined with only a specific disc is included in the local storage, the optical recording/reproducing device 10 reads the file system information 41 stored in the local storage 15, and reads disc file system information 42 including the disc package 421, such that it forms a virtual file system (VFS) 40. The virtual file system (VFS) 40 is indicative of a file system virtually formed to integrate the file system of the local storage 15 and the file system of the loaded disc into a single medium, such that the virtual file system (VFS) 40 can manage the two file systems as one medium.

The optical recording/reproducing device forms a new virtual package to simultaneously reproduce original data recorded in the disc and additional data recorded in the local storage using the above-mentioned virtual file system (VFS) 40. For this purpose, the optical recording/reproducing device 10 reads a binding unit (binding unit for Disc_id #1) associated with the loaded disc (e.g., Disc_id #1) from the file system of the local storage 15, and performs a binding operation for replacing the read binding unit with the file structure of the loaded disc (Disc_id #1) or appending the read binding unit to the file structure of the loaded disc (Disc_id #1).

The virtual package formed by the above-mentioned binding operation is indicative of a file structure for reproducing/managing an original clip 422 and an additional clip 412. The original clip 422 is composed of original data recorded in the disc. The additional clip 412 is composed of additional data recorded in the local storage.

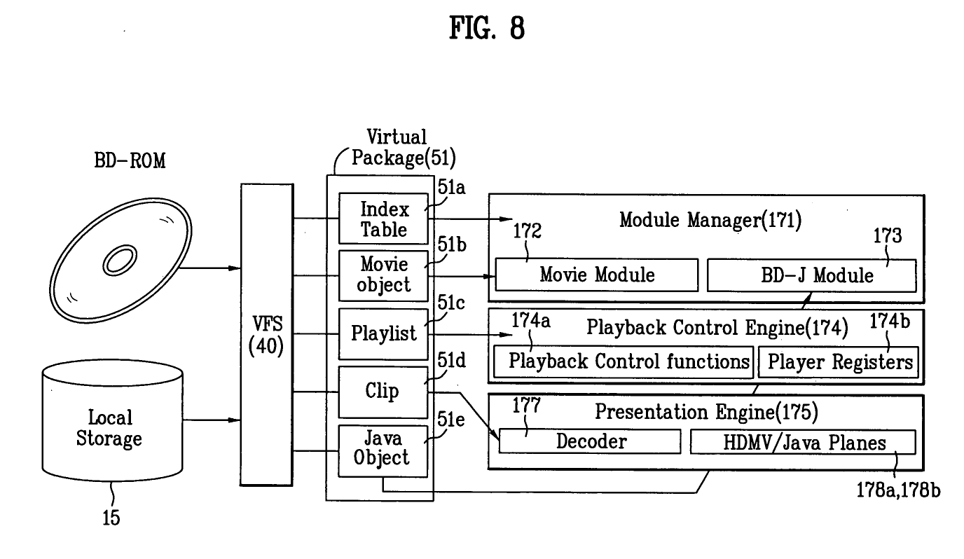

FIG. 8 is a conceptual diagram illustrating a relationship between the playback system 17 and file information contained in the virtual package 51 formed by the binding operation according to the present invention. In association with the above-mentioned description, directories and files of the virtual package 51 are equal to those of the file structure shown in FIG. 2.

The index file 51a contained in the virtual package 51 is provided to the module manager 171 contained in the playback system 17. If a user enters a specific title, the module manager 171 operations one of the movie module 172 and the BDJ module 163 according to attribute information of the selected title. In other words, if the title selected by the user is a movie title, the movie module 172 is executed by the movie object 51b. Otherwise, if the title selected by the user is a Java title, the BDJ module 173 is executed by the Java object 51e.

The playlist file (PlayList) 51c contained in the virtual package 51 is provided to the playback control engine 174 contained in the playback system 17. The playback control engine 174 receives a control signal from either the movie module 172 or the BDJ module 173, and executes a corresponding playlist file by referring to information of the player registers 174b in which playback environment information and playback state information of a player are stored.

The clip 51d contained in the virtual package 51 is provided to the presentation engine 175 contained in the playback system. Specifically, the clip 51d is reproduced in the form of one of audio data, graphic data, and text subtitle data by the decoder 177 contained in the presentation engine 175 according to stream types information. The reproduced stream is provided to the user via the HDMV plane 178b and/or the Java plane 178b. A detailed description of the decoder will be described later with reference to FIGS. 10a□10b.

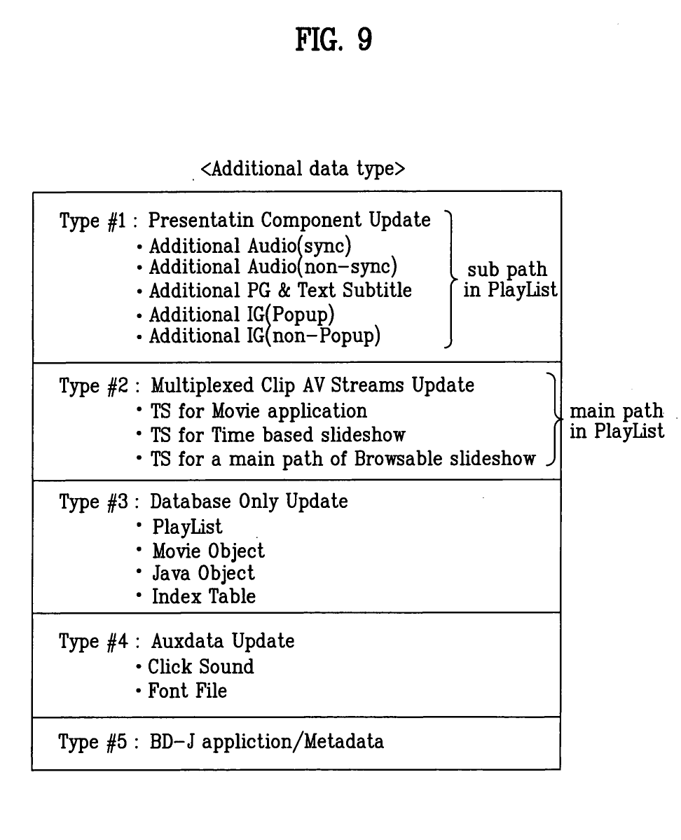

FIG. 9 exemplarily shows a variety of additional data types stored in a local storage according to the present invention. Specifically, FIG. 9 shows five additional data types according to additional data attributes.

Firstly, the additional data type #1 includes a plurality of data units for assisting the original data, and is managed via a sub-path contained in the playlist file. For example, the additional data type #1 includes additional data, additional presentation graphic (PG) data, additional interactive graphic (IG) data, and additional text subtitle data, etc. In association with the above-mentioned description, the additional audio data is classified into sync audio data synchronized with original video data, and non-sync audio data unsynchronized with the original video data. The additional IG data is classified into Popup IG data constructing a popup menu, and non-Popup IG data acting as general interactive graphic (IG) data not contained in a popup menu.

In association with the above-mentioned description, the original data recorded in the disc manages the sync audio data synchronized with the video data as a main path of the playlist file, and manages the non-sync audio data unsynchronized with the video data as a sub-path of the playlist file. The original interactive graphic (IG) data recorded in the disc manages the non-Popup IG data, acting as general interactive graphic (IG) data not contained in the popup menu, as a main path of the playlist file. The Popup IG data contained in the popup menu is managed as a sub-path of the playlist file.

In more detail, the additional data type #1 is managed as a sub-path of the playlist file. However, although the same audio data or the same interactive graphic (IG) data is given to original data in the same manner as in the additional data type #1, the original data divides a path of the playlist file into a main path and a sub-path according to attribute information of the audio data or the IG data. A difference between the original data and the additional data type #1 affects a structure and operations of the decoder 177, and a detailed description thereof will be described later with reference to FIGS. 10a□10b.

Secondly, the additional data type #2 includes a plurality of multiplexed-clip AV streams which are replaced with original data or are appended to the original data. Specifically, the additional data type #2 is managed via a main path of the playlist file. For example, the additional data type #2 includes a general AV stream (denoted by “TS for Movie application”) for constructing a movie title of a moving image, an AV stream (denoted by “TS for Time based slideshow”) for constructing still images (including audio data) in the form of a time-based slideshow, and a video stream (denoted by “TS for a main path of browsable slideshow”) for constructing still images (having no audio data) in the form of a browable slideshow of the main path.

In other words, the additional data type #2 acts as a stream including video data. The additional data type #2 is managed as a main path of the playlist file in the same manner as in original video data recorded in the disc.

Thirdly, the additional data type #3 includes a plurality of data units (denoted by “Database only”) associated with conversion of a reproduction scenario for reproducing original data. For example, in the case where the order of the playitems contained in the playlist is changed, or the index file “index” or the object file “MovieObject” or “JavaObject” is changed, this means that only a reproduction/management file is changed/added with the absence of an actual additional clip. In other words, the additional data type #3 does not construct a data stream differently from the above-mentioned additional data types #1 and #2, such that it does not require data reproduction using the decoder 177.

However, if the additional data type #3 is combined with the disc file structure and is contained in the virtual package 51, the additional data type #3 is transmitted to the module manager 171 of the playback system 17 when the additional data type #3 is set to the index table 51a, is transmitted to the movie module 172 when the additional data type #3 is set to the movie object 51b, is transmitted to the BDJ module 173 when the additional data type #3 is set to the Java object 51e, or is transmitted to the playback control engine 174 when the additional data type #3 is set to the playlist 51c.

Fourthly, the additional data type #4 includes a plurality of data units (Auxdata) associated with the auxiliary directory (AUXDATA) contained in the file structure. For example, the additional data type #4 is associated with the addition of click sound information or the addition of a font file for a text subtitle. In other words, the additional data type #4 does not construct a data stream differently from the above-mentioned additional data types #1 and #2, such that it does not require data reproduction using the decoder 177.

Fifthly, the additional data type #5 includes a plurality of data units used as system reproduction information, for example, the above-mentioned Java application program, and/or metadata used as system information, etc. In this case, the additional data type #5 does not require data reproduction using the decoder 177.

In association with the above-mentioned description, the additional data type #1 and the additional data type #2 from among the above-mentioned additional data types #1□#5 are indicative of clips (i.e., stream data) differently managed according to the sub-path and the main path contained in the playlist file. The streams can be processed in various ways by the decoder 177 according to paths associated with the streams. A method for decoding the original data recorded in the disc and the additional data types #10#2 using the decoder 177 will hereinafter be described with reference to FIGS. 10a□10b.

FIG. 10a is a block diagram illustrating the decoder 177 for use in the playback system according to a first preferred embodiment of the present invention.

Referring to FIG. 10a, the decoder 177 includes a variety of decoders to perform different decoding operations according to data attributes, i.e., a video decoder 177a, a presentation graphic (PG) decoder 177b, an interactive graphic (IG) decoder 177c, an audio decoder 177d, and a text subtitle (TXTST) decoder 177e.

The decoder 177 includes a plurality of components to decode a main-path stream, i.e., a receiver buffer (RBl) 177j for buffering a stream, a source depacketizer 177h for de-packetizing an input stream into individual PID streams, and a PID filter 177f for filtering the PID streams to be processed by a corresponding decoder.

The decoder 177 includes a plurality of components to decode a sub-path stream, i.e., a receiver buffer (RB2) 177k for buffering a stream, a source depacketizer 177i for de-packetizing an input stream into individual PID streams, and a PID filter 177g for filtering the PID streams to be processed by a corresponding decoder.

The decoder 177 further includes a selection unit 100. The selection unit 100 selects one of original data recorded in the disc and additional data recorded in the local storage, and determines whether the selected data is the main-path stream or the sub-path stream. In association with the above-mentioned description, the selection unit 100 may also exist outside of the decoder 177.

Operations of the selection unit 100 are controlled by the playback control engine 174 contained in the playback system 17. For example, the playback control engine 174 analyzes file information contained in the playlist file 51c associated with a user-desired title in the virtual package 51, determines whether data to be reproduced is original data or additional data, and selects a storage medium (i.e., a disc or a local storage) according to the determined result. Also, the playback control engine 174 determines whether each of clips contained in the original data and the additional data is the main-path stream or the sub-path stream, and determines a decoding path according to the determined result.

Therefore, if the stream corresponding to the clip is determined to be the main-path stream, and is filtered by the PID filter 177f, the stream is classified into a video stream “V”, an audio stream “sync A” synchronized with the video stream “V”, a presentation graphic stream “PG”, and a general interactive graphic (IG) stream “non-Popup IG” different, from, a popup menu. Individual streams are decoded by their associated decoders 177a, 177b, 177c, and 177d.

In association with the above-mentioned description, the video stream “V” from among the plurality of streams filtered by the PID filter 177f can be read from the original data recorded in the disc or the additional data stored in the local storage. However, the audio stream “sync A” synchronized with the video stream “V”, the general interactive graphic (IG) stream “non-Popup IG” different from the popup menu, and the presentation graphic (PG) stream can be read only from the original data recorded in the disc. As previously stated in FIG. 9, the additional data type #1 is managed as a sub-path, such that the PID filter 177f for filtering the stream contained in the main path does not filter the additional data type #1.

In the meantime, if the stream corresponding to the clip is determined to be the sub-path stream, and is filtered by the PID filter 177g, the stream is classified into all interactive graphic streams “Popup IG” and “non-Popup IG”, a presentation graphic stream “PG”, all audio streams “sync A” and “non-sync A”, and a text subtitle stream “TXTST”. Individual streams are decoded by their associated decoders 177b, 177c, 177d, and 177e.

In association with the above-mentioned description, the presentation graphic stream “PG”, the general IG stream “non-Popup IG” different from the popup menu, and the synchronized audio stream “sync A” from among the plurality of streams filtered by the PID filter 177g can be read from the additional data recorded in the local storage. The Popup IG stream “Popup IG” acting as a popup menu, the audio stream “non-sync A” unsynchronized with the video stream “A”, and the text subtitle stream (TXTST) can be read from the original data recorded in the disc or the additional data recorded in the local storage.

FIG. 10b is a block diagram illustrating the decoder 177 according to a second preferred embodiment of the present invention.

Compared with the decoder shown in FIG. 10a, the decoder 177 shown in FIG. 10b divides a decoding path for decoding a sub-path stream into two sub-path streams (i.e., first and second sub-path streams), differently from the decoder of FIG. 10a. For the convenience of description, the first sub-path stream is referred to as a first sub-path stream (Sub path 1), and the second sub-path stream is referred to as a second sub-path stream (Sub path 2).

Referring to FIG. 10b, the decoder 177 includes a variety of decoders to perform different decoding operations according to data attributes, i.e., a video decoder 177a, a presentation graphic (PG) decoder 177b, an interactive graphic (IG) decoder 177c, an audio decoder 177d, and a text subtitle (TXTST) decoder 177e.

The decoder 177 includes a plurality of components to decode a main-path stream, i.e., a receiver buffer (RB1) 177j for buffering a stream, a source depacketizer 177h for de-packetizing an input stream into individual PID streams, and a PID filter 177f for filtering the PID streams to be processed by a corresponding decoder, in the same manner as in FIG. 10a.

The decoder 177 includes a plurality of components to decode a first sub-path stream (sub path 1), i.e., a receiver buffer (RB2) 177k1 for buffering a stream, a source depacketizer 177i1 for de-packetizing an input stream into individual PID streams, and a PID filter 177g1 for filtering the PID streams to be processed by a corresponding decoder.

The decoder 177 includes a plurality of components to decode a second sub-path stream (sub path 2), i.e., a receiver buffer (RB3) 177k2 for buffering a stream, a source depacketizer 177i2 for de-packetizing an input stream into individual PID streams, and a PID filter 177g2 for filtering the PID streams to be processed by a corresponding decoder.

The decoder 177 further includes a selection unit 100. The selection unit 100 selects one of original data recorded in the disc and additional data recorded in the local storage, and determines whether the selected data is one of the main-path stream, the first sub-path stream (sub path 1), and the second sub-path stream (sub path 2). In association with the above-mentioned description, the selection unit 100 may also exist outside of the decoder 177.

Operations of the selection unit 100 are controlled by the playback control engine 174 contained in the playback system 17. For example, the playback control engine 174 analyzes file information contained in the playlist file 51c associated with a user-desired title in the virtual package 51, determines whether data to be reproduced is original data or additional data, and selects a storage medium (i.e., a disc or a local storage) according to the determined result. Also, the playback control engine 174 determines whether each of clips contained in the original data and the additional data is the main-path stream, the first sub-path stream (sub path 1), or the second sub-path stream (sub path 2), and determines a decoding path according to the determined result.

In association with the above-mentioned description, the first sub-path stream (sub path 1) can be read from the original data and the additional data, and the second sub-path stream (sub path 2) can be read only from the additional data.

Therefore, if the stream is determined to be the first sub-path stream (sub path 1), and is filtered by the PID filter 177g1, the stream is classified into an interactive graphic (IG) stream “Popup IG” acting as a popup menu, an audio stream “non-sync A” unsynchronized with the video stream “V”, and a text subtitle stream (TXTST). If the stream is determined to be the second sub-path stream (sub path 2), and is filtered by the PID filter 177g2, the stream is classified into a presentation graphic (PG) stream, a general interactive graphic (IG) stream “non-Popup IG” different from the popup menu, and a synchronized audio stream “sync A”. The first filtered sub-path (sub path 1) and the second filtered sub-path (sub path 2) are decoded by their association decoders 177b, 177c, 177c, and 177c.

In the meantime, if the stream is determined to be the main-path stream, and is filtered by the PID filter 177f, the stream is classified into a video stream “V”, an audio stream “sync A” synchronized with the video stream “V,” a presentation graphic stream “PG”, and a general interactive graphic stream “non-Popup IG”, in the same manner as in FIG. 10a. Individual streams are decoded by their associated decoders 177a, 177b, 177d, and 177d.

The first preferred embodiment for implementing the decoder 177 in FIG. 10a, and the second preferred embodiment for implementing the decoder 177 in FIG. 10b can be selectively used by a selection command of a decoder manufacturer. For example, the first preferred embodiment including two decoding paths can greatly reduce product costs as compared to the second preferred embodiment including three decoding paths. The second preferred embodiment can more stably perform necessary operations at high speed as compared to the first preferred embodiment.

As apparent from the above description, a method and apparatus for reproducing data from a recording medium using a local storage according to the present invention can effectively reproduce the original data recorded in the recording medium and the additional data stored in the local storage, resulting in the creation of more convenient functions for a user.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An apparatus for reproducing data of a recording medium wherein original data constructing a first title and a second title having different attributes is recorded, using a local storage, comprising:
a local storage for downloading additional data associated with the first title and/or the second title from an external part, and storing the downloaded additional data; and
a playback system for forming a virtual file system to reproduce the original data and the additional data, and reproducing the first title or the second title,
wherein the playback system includes:
a first module for reproducing the original data and the additional data, which are associated with the first title; and
a second module for reproducing the original data and the additional data, which are associated with the second title.

2. The apparatus according to claim 1, wherein the first title is an HDMV title, and the second title is a Java title.

3. The apparatus according to claim 2, wherein the first module is a movie module for reproducing the HDMV title, and the second module is a Java (BDJ) module for reproducing the Java title.

4. The apparatus according to claim 3, wherein the playback system further includes:
a playback control engine for controlling reproduction of a playlist file; and
a module manager for receiving a control command from an external part, and controlling execution operations of the movie module and the BD Java (BDJ) module according to the received control command.

5. The apparatus according to claim 3, wherein the playback system further includes:
an application program for controlling a download operation of the additional data.

6. The apparatus according to claim 5, wherein the application program is executed by a Java application contained in the BD Java (BDJ) module.

7. The apparatus according to claim 1, wherein the playback system further includes:
a resident application for managing a file recorded in the local storage.

8. The apparatus according to claim 4, wherein the playback control engine includes:
at least one playback control function for controlling reproduction of the playlist file; and
at least one player register for storing a reproduction state.

9. The apparatus according to claim 4, wherein the module manager includes a user event manager for managing a user command.

10. The apparatus according to claim 9, wherein the user event manager receives a user command, and transmits the user command to the movie module and the BD Java module according to characteristic information of the received user command.

11. The apparatus according to claim 10, wherein the movie module includes:
a UO controller for receiving a user command from the user event manager, and controlling the playback control engine using the received user command.

12. The apparatus according to claim 10, wherein the BD Java (BDJ) module includes:
a Java VM for receiving a user command from the user even manager, and executing a Java program using the received user command.

13. The apparatus according to claim 10, wherein the BD Java (BDJ) module further includes:
an application manager for differently managing a plurality of applications contained in the Java program.

14. The apparatus according to claim 3, wherein the playback system further includes:
a presentation engine for controlling a reproduced image of the HDMV title.

15. The apparatus according to claim 3, wherein the playback system further includes:
a decoder for simultaneously decoding the original data recorded in the recording medium and/or the additional data recorded in the local storage.

16. The apparatus according to claim 15, wherein the decoder includes two decoding paths.

17. The apparatus according to claim 16, wherein the two decoding paths are a path for decoding a main stream, and a path for decoding a sub-stream.

18. The apparatus according to claim 15, wherein the decoder includes three decoding paths.

19. The apparatus according to claim 18, wherein the three decoding paths are a path for decoding a main stream, a path for decoding a first sub-stream, and a path for decoding a second sub-stream.

20. The apparatus according to claim 19, wherein the first sub-stream is indicative of a stream capable of being read from the original data and the additional data, and the second sub-stream is indicative of a stream capable of being read from only the additional data.

21. An apparatus for reproducing data of a recording medium using a local storage, comprising:
a recording/reproducing unit for reading original data from the recording medium;
a local storage for downloading additional data associated with the recording medium from an external part, and storing the downloaded additional data;
a selection unit for selecting the original data or the additional data, and selecting a decoding path of the selected original data or a decoding path of the selected additional data; and
a decoder for including at least two decoding paths, and performing a decoding operation according to the selected data and the selected decoding path of the selection unit.

22. A method for reproducing data of a recording medium using a local storage, comprising the steps of:
(a) reading a binding unit associated with a loaded recording medium from the local storage;
(b) performing a binding operation for combining the binding unit with a file structure contained in the recording medium, and forming a virtual package in which a playlist file including a main path and a sub-path is contained; and
(c) separating a first path capable of decoding a stream of the main path from the playlist file, separating a second path capable of decoding a stream of the sub-path from the playlist file, and decoding the first path and the second path in different ways.

23. The method according to claim 22, wherein the decoding of the second path includes the step of:
differently decoding a path for decoding a stream capable of being read from original data and additional data and a path for decoding a stream capable of being read from only the additional data.

24. A method for reproducing data of a recording medium using a local storage, comprising the steps of:
(a) reading original data from a recording medium;
(b) downloading additional data associated with the recording medium from an external part, and storing the downloaded additional data;
(c) selecting the original data or the additional data, and selecting a decoding path of the selected original data or a decoding path of the selected additional data; and
(d) performing a decoding operation according to the selected data and the selected decoding path.
